(19) United States
(12) Patent Application Publication
(10) Pub. No.: US 2014/0214933 A1
(43) Pub. Date: Jul. 31, 2014

(54) Method and Apparatus for Vehicular Social Networking

(71) Applicant: FORD GLOBAL TECHNOLOGIES, LLC, Dearborn, MI (US)

(72) Inventors: Yimin Liu, Ann Arbor, MI (US); Perry Robinson MacNeille, Lathrup Village, MI (US); Oleg Yurievitch Gusikhin, West Bloomfield, MI (US)

(73) Assignee: FORD GLOBAL TECHNOLOGIES, LLC, Dearborn, MI (US)

(21) Appl. No.: 13/751,391

(22) Filed: Jan. 28, 2013

(51) Int. Cl. H04L 29/08

(52) U.S. Cl. CPC H04L 67/02
USPC 709/204

(57) ABSTRACT

A system includes a processor configured to communicate with a remote server to receive a list of friends who are currently driving their respective vehicles. The processor is also configured to display the list of friends in a selectable manner. The processor is further configured to receive selection of one or more friends from the list and send data to the remote server to be shared with the one or more selected friends.

### TECHNICAL FIELD

The illustrative embodiments generally relate to a method and apparatus for vehicular social networking.

### BACKGROUND

Social networking is a broadly expanding concept, infiltrating and becoming useful in a number of varied portions of our everyday lives.

For example, U.S. 2007/0162550 generally discusses an automobile-to-automobile instant-messaging system that enables a user of a first automobile to selectively send a communicative message to a user of a second automobile, the communicative message being addressed to the second automobile based at least in part upon its location with respect to the first automobile. In some embodiments the message is addressed also based upon the road and/or direction of travel of the second automobile, In an example embodiment, the system comprises a locative server in wireless communication with processors of each of the first and second automobiles, the locative server repeatedly receiving locative data from each automobile indicating its substantially current geospatial location; and wherein messaging data is sent to the second automobile that originates from the first automobile, the sending of the messaging data being dependent at least in part upon a determined spatial proximity between the first automobile and the second automobile.

In another example, U.S. 2011/0238752 generally discusses a social networking hub located in an automobile that provides updates to a social networking site includes an information gathering module that receives and stores information from one or more information sources. The hub also includes an update manager that receives information from the information gathering module and provides some or all of the information to the social networking site through an internet connection.

### SUMMARY

In a first illustrative embodiment, a system includes a processor configured to communicate with a remote server to receive a list of friends who are currently driving their respective vehicles. The processor is also configured to display the list of friends in a selectable manner. The processor is further configured to receive selection of one or more friends from the list and send data to the remote server to be shared with the one or more selected friends.

In a second illustrative embodiment, a computer-implemented method includes communicating with a remote server to receive a list of friends who are currently driving their respective vehicles. The method also includes displaying the list of friends in a selectable manner. The method further includes receiving selection of one or more friends from the list and sending data to the remote server to be shared with the one or more selected friends.

In a third illustrative embodiment, a computer readable storage medium stores instructions that, when executed by a processor of a vehicle computing system, cause the processor to perform a method including communicating with a remote server to receive a list of friends who are currently driving their respective vehicles. The method also includes displaying the list of friends in a selectable manner. The method further includes receiving selection of one or more friends from the list and sending data to the remote server to be shared with the one or more selected friends.

### BRIEF DESCRIPTION OF THE DRAWINGS

FIG. 1 shows an illustrative vehicle computing system;

FIG. 2 shows an illustrative example of a system of users capable of communication;

FIG. 3 shows an illustrative process for data collection and analyzation for social network action;

FIG. 4 shows an illustrative example of a social network operation;

FIG. 5 shows an illustrative example of a process for social network interaction;

FIG. 6 shows an illustrative example of a group destination process;

FIG. 7 shows an illustrative example of a group chat process; and

FIGS. 8A-8C show illustrative processes for group meet up handling.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

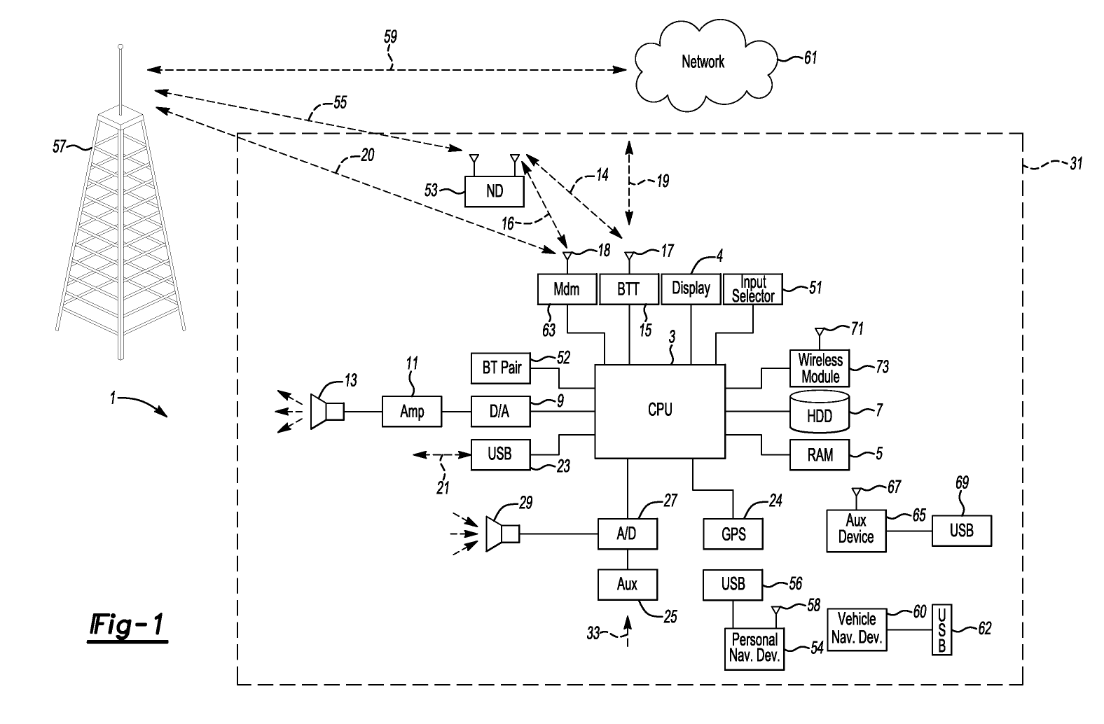

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

People like to use digital social networking to stay connected. Busy schedules make it hard to see friends in person, and digital social networking can make it easier to stay in touch with friends and make new friends. A social networking service is an online service, platform or site that focuses on building social networks or social relations between people who share interests, locations and/or activities.

Current social network platforms have not expanded to encompass vehicle information systems. Users in a vehicle can have difficulty connecting, and driver experiences are not currently shareable on demand.

Verbally controlled social networking systems can be provided to vehicles, which will allow drivers to undistractedly communicate with other drivers and various social networking systems. In one embodiment, a system is contemplated that creates a network between multiple vehicles in which drivers are currently traveling.

The illustrative embodiments present social networking solutions that provide data collection and improve the driving experience. Using HMI technology, drivers can use existing vehicle computing solutions and form social groups with other drivers. This can provide communication between drivers, shared driver experiences, route sharing, group scheduling, etc.

Current video computing solutions can be altered to provide more control to the drivers. These services can include, for example, instant voice messaging, friend location evaluation, data sharing, trip experience sharing, etc. By using these controls, drivers can know what their friends are doing, what their friends are experiencing, etc. Any time two drivers are both in their vehicles, they can be connected via the illustrative embodiments.

Illustrative embodiments can include, for example, a control application that runs in the vehicle and uses a spoken dialog system. The system can interact with a user, track where the user is located, upload files, record voice messages for other users, gather data about the vehicle and the driver environment. The system can also contain an informational filter or computation system that processes a users commands. The filter can also include a linguistic analyze, network analyzer and vehicle sensor analyzer and build a model of driver's language, mood and personality from the linguistic attributes of a dialog, driver's interests, needs, etc. The system can further include a social network server that receives and processes the information from other users in other vehicles and provide it to a driver.

For example, a driver could request “find friends close to my current location.” The command may be sent to the message cloud through a control application. A message filter could process the requests and obtain location information from other drivers in a social group or show a map with locations of the user's friend. The information can then be provided to the driver. At the same time, other drivers may seek to initiate communication with each other through messaging or other requests. Some of the friends could decide to go to a movie, for example. One person could send out a time or destination, and the information could be uploaded to all of the other drivers.

While the user benefits from the social network features, the system is also collecting the vehicle's sensor data and driver's data to be statistically analyzed and converted into user preference models that are usable for media selection, advertisement selection, etc. The data can also be used by an OEM to gather information on the driving experience to inform future design decisions.

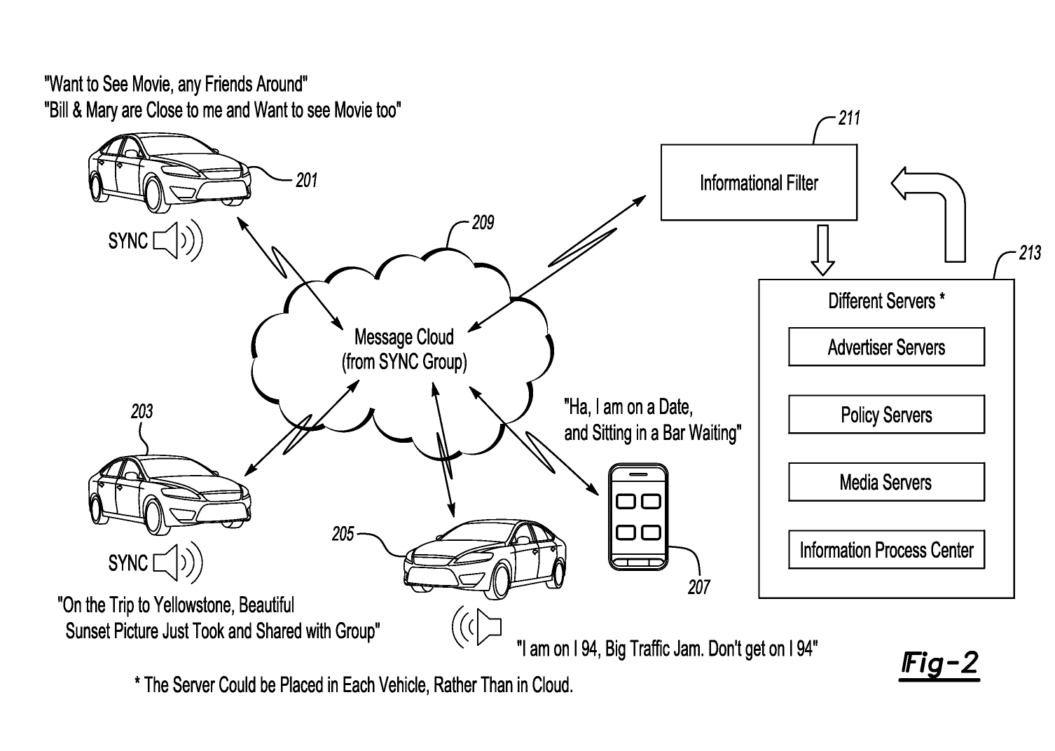

FIG. 2 shows an illustrative example of a system of users capable of communication using the illustrative embodiments. In this example, there are a plurality of users in the system 201, 203, 205 and 207. User 207 is not actually in a vehicle, but has logged on to the social vehicle network through a mobile device. Messages from the people in the network pass through a remote server 209 to the other users.

Running on the cloud is an informational filter 211 process that links with different servers to gather and provide requested information. The server can communicate with other servers 213 as well, such as, but not limited to, advertisement servers, policy servers, media servers, etc.

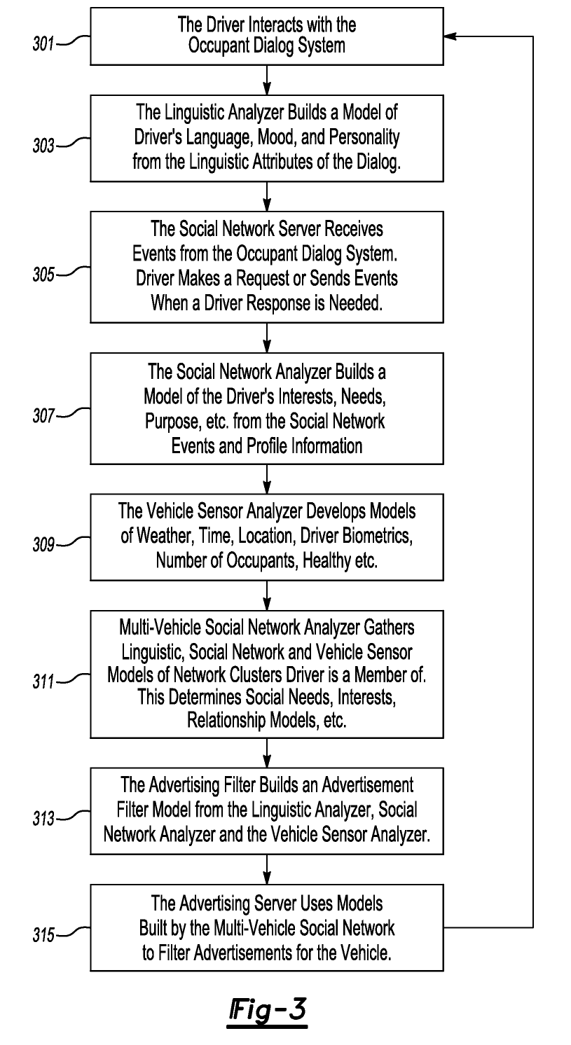

FIG. 3 shows an illustrative process for data collection and analyzation for social network action. In this illustrative example, data from a particular driver will be collected during drivers, and analyzed to determine media, data, advertisements and other information that a driver may be interested in.

In this example, the driver interacts with the occupant dialog system 301. This system allows the driver to verbally control and interact with the social networking system. In this example, the system includes a linguistic analyzer. The linguistic analyzer builds a model of, for example ,without limitation, the driver's language, mood and personality from the linguistic attributes of the incoming dialogue 303. In this example, the dialogue includes the driver's commands and also the driver's responses to advertisements and, for example, surveys.

Then, in this illustrative example, a social network server receives events from the occupant dialogue system 305. These can include driver requests events or, in another example, the system can send events to a vehicle when a driver response is needed (for example, when another driver is requesting communication). A social network analyzer can build a model of the driver's interests, needs, a purpose, etc. 307. This can be derived from social network events, profile information, etc.

Also, a vehicle sensor analyzer 309 may be included with a vehicle. The sensor analyzer may develop models of weather, time, locations, driver biometrics, numbers of occupants and other relevant vehicle sensor information. A multi-vehicle social network analyzer may gather linguistic, social network and vehicle sensor model data of network clusters that a driver is a member. This could determine social needs interests, relationship models, etc.

An advertising filter 313 can build an advertisement filter model from the linguistic analyzer, social network analyzer and vehicle sensor analyzer. This advertisement model can be used by an advertising server 315 to filter advertisements for delivery to a driver or other users.

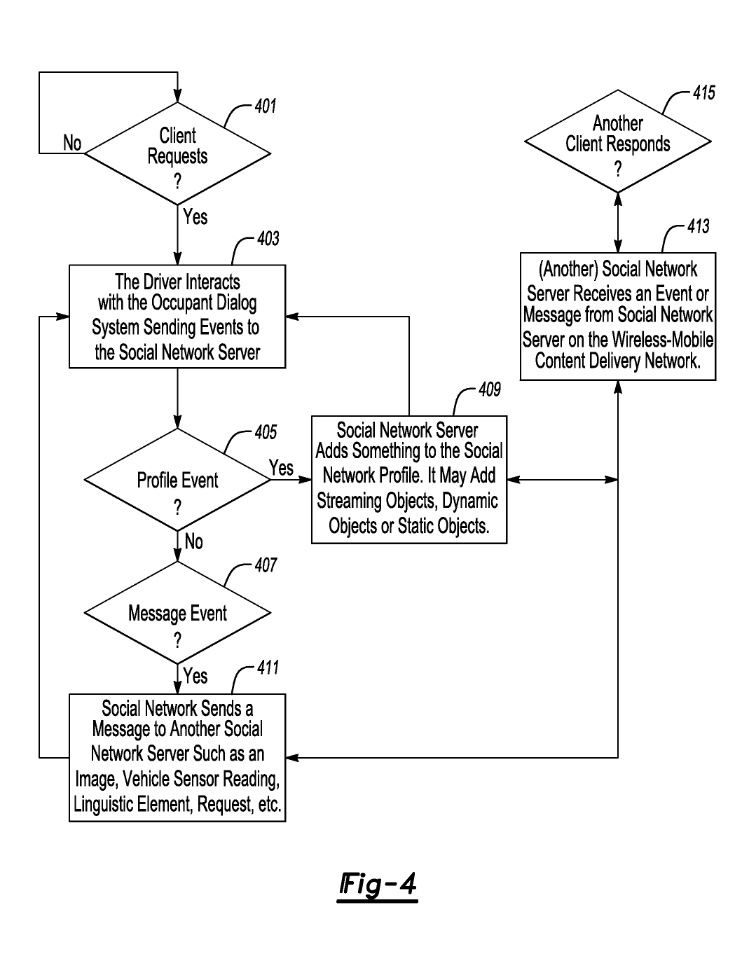

FIG. 4 shows an illustrative example of a social network operation. In this illustrative example, the process waits for a client request 401. The request could come from a driver of the vehicle, or, although not shown, the request could be from another driver requesting interaction with the driver.

If the current driver requests usage of the system, the driver may then interact with the occupant dialog system, sending events to a social network server. The driver can request a variety of interactions, including, but not limited to, a profile event or a message event 407.

In the case of a profile event, for example, the social network server may have added something to a social network profile 409. For example, the driver may request to upload a status change, a video, an image, etc. In other instances, a different driver may have updated their profile, and the updated profile may be sent to friends who are also online.

In the case of a message event, for example, the user may have requested to send a video, audio or other message to another user. The social network can send a message to another social network server 411. The message can include an audio message, a video message, an image, a request, etc.

At the same time the illustrative embodiment is working for one user, other social network processes may be working on behalf of other users. If there is another client 415 that causes interactions, then other social network servers may be receiving events or messages from their respective users. These various servers can interact with each other, creating a comprehensive social network of many drivers.

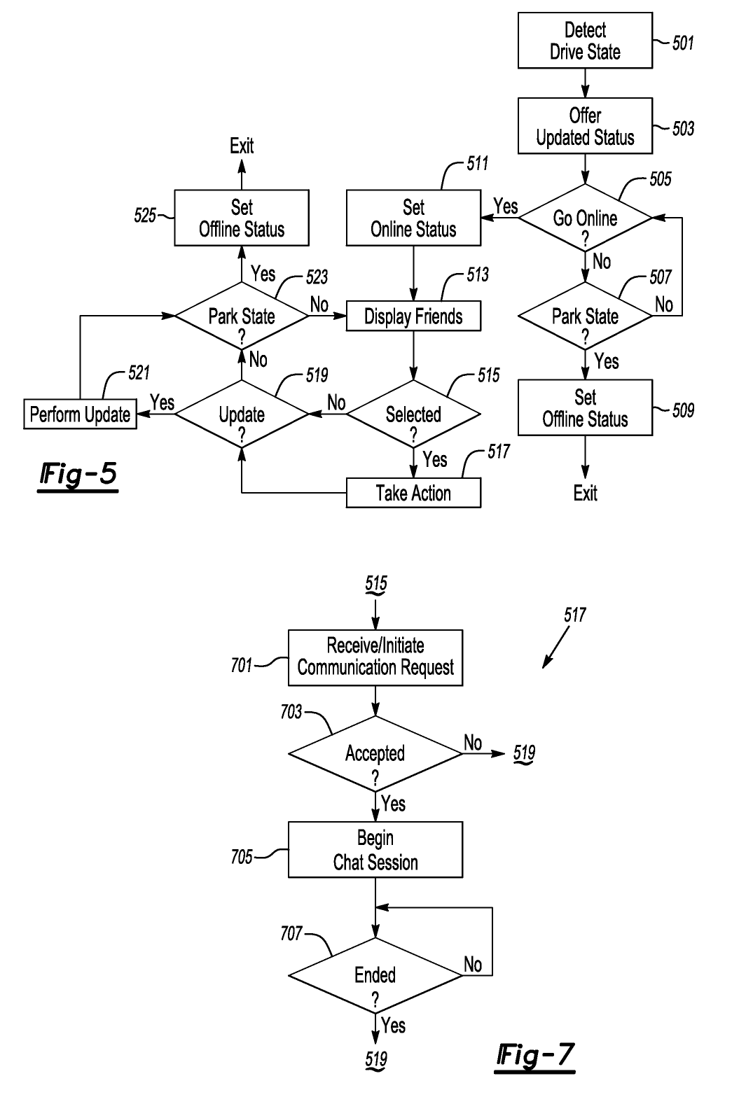

FIG. 5 shows an illustrative example of a process for social network interaction. In this illustrative example, the process detects that a vehicle in a drive state 501. Since the network is designed, in this embodiment, to connect various drivers, it is useful to know that a particular person is driving a vehicle. The network can identify a driver or, in another embodiment, a vehicle may be provided with a profile, regardless of who is driving.

In this example, the process then offers to update a driver status 503. For example, the driver status can reflect that the driver is now online. On the other hand, the driver may not wish to notify friends that the driver is online, if the driver doesn't wish to interact with the social network.

If the driver doesn't wish to go online at this time, the process may continue to wait while the vehicle is driving, in case the driver wishes to indicate that they are available. Once the vehicle enters a park state 507, the process will terminate, setting (if not already set) an offline status for the driver 509.

If the driver wants to go online, the process will reflect an online status for the driver 511. An update can be sent to a remote server, or to the cloud, so that other drivers can see that the driver is available for communication. Further, the process can retrieve information relating to the driver's friends from the cloud, in order to display to the driver 513 who else is currently available for communication (e.g., which other friends are also currently driving their vehicles).

Once a list of friends has been displayed, the driver can select from those friends for communication 513. The driver can directly communicate with the other drivers, or can send them images, video, status updates, meeting/social requests, direction requests, etc. If the driver has selected one or more friends 515, the process attempts to determine if there is an action associated with those friends 517.

For example, the driver may wish to initiate a chat session with one or more friends. The driver can select friends and request communication with those friends. Once one or more friends has accepted the request, the driver can use verbal chat to communicate with one or more people. If the vehicle is equipped with a camera, video chat could also be used. In other instances, the driver may want to request a social meeting (dinner, movie) or share an experience, traffic report, etc.

In addition to performing any actions related to the one or more other users, or even if user interactions are not requested, the process may perform updates related to a user status 519. For example, if a driver arrives at a known location or a destination, the process may report the drivers status, such as “Bob Smith is now at McDonalds on Maple Road in Waterford.” Or the driver's intended destination could be updated, e.g., “Bob Smith is headed to McDonalds on Maple Road in Waterford. Estimated arrival at 3:17 p.m.” Of course, a user can control these updates so as not to broadcast undesirable status updates.

If the update is desired 519, the process can perform the update 521, such as, but not limited to, uploading a new user status to the cloud. The process can continue to update user statuses and or provide for interaction with other users, until a park state is detected 523. Once the vehicle is in park, the process can update the user's status as offline 525, which can remain as the state until the vehicle is again used.

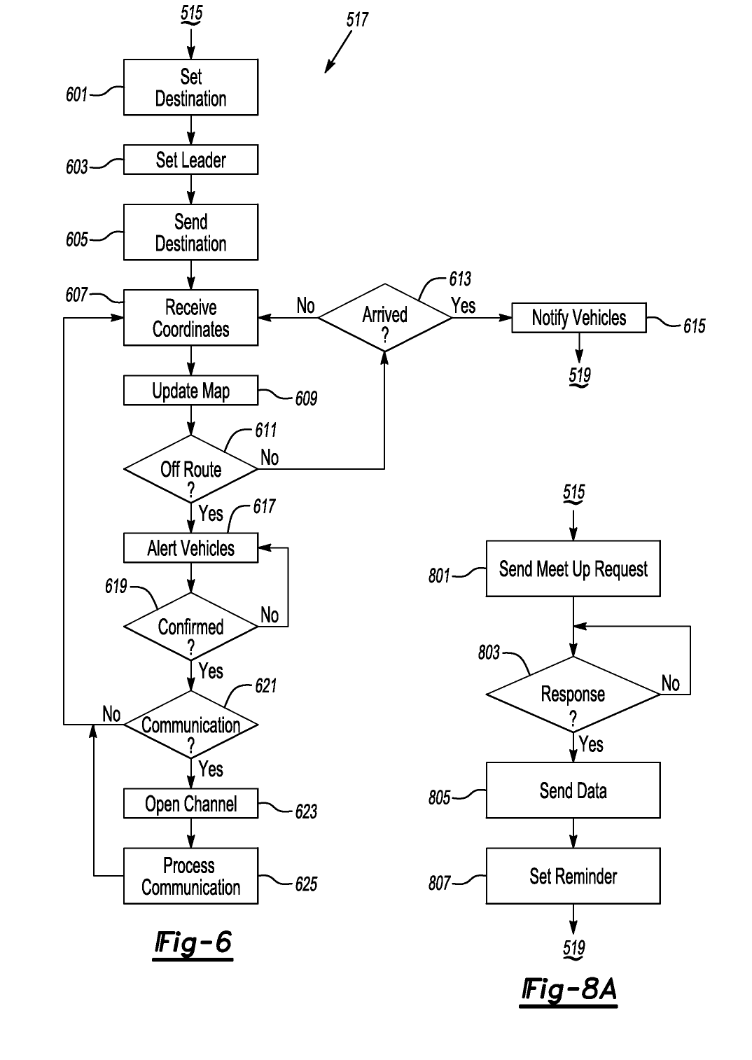

FIG. 6 shows an illustrative example of a group destination process. In this illustrative example, the process allows a group of people who are all traveling to a common destination to track group movement, receive group updates, and generally travel as a group. For example, if five people leave a point of origin as a group, it may be difficult for a lead driver to drive such that all members may follow the driver. Such driving requires sometimes slow and dangerous driving, as well as timing lights and lane changes to allow the entire group to follow. Using the illustrative embodiments, each group member can receive directions to a destination. Also, if a user breaks down, makes a wrong turn, gets pulled over or otherwise is delayed, the process can update the other users so they know where the missing member is located.

If users leave from different points of origin, the process still can facilitate group travel to a common destination. Similar to the group-travel described above, group status updates can let users know when others will arrive, and inform everyone of any problems a member may encounter.

In this illustrative example, the process receives a destination 601 from a user who will act as the leader 517. This could, for example, correspond to a destination set into a navigation process. Also, in this example, the process sets the destination setting vehicle as the group leader 603. The group leader can also correspond to a person who sends a request to establish the group (for the purpose of joint travel) in the first place. Once a leader is designated (if desired), the process can send the destination to the other drivers in the group 605. Even if a new driver joins the group, the process can send the required information and destination data to the new driver, allowing them to interact with the group.

In this illustrative embodiment, the process is capable of updating a vehicle map with the locations of the fellow travelers. This can provide a visual representation of where each group member is currently located. In this example, the process receives coordinates 607 from the various members of the group. The map is updated for each of the group members 609, showing where the members are located. If a member's location is off the map, since they may not be near enough to fit on the map image, the process could show, for example, an arrow on the edge of the map, indicating approximately where the group member is located relative to the driver.

Next, the process determines if any of the users appear to be off-route 611. For example, an off-route notification from another vehicle could be received, indicating an off-route (e.g., wrong turn) condition from that vehicle. Or, if all users are traveling together, the process could detect any off-route users based on the roads on which the users are currently located. If there are no off-route vehicles, the process checks to see if the current driver has arrived 613.

If the driver has arrived, the process can notify the other vehicles that the driver is at the destination 615. In a similar manner, other vehicles will update the group as they arrive, so that all of the drivers know when others are at the destinations and who is still en-route.

If one or more of the vehicles, such as the driver's vehicle, is off-route, the process can alert the other vehicles 617. In this example, the process requests communication from the other vehicles so that a current driver knows that the other drivers recognize the off-route condition. For example, if a group were taking a trip of several hundred miles, it might be desirable to wait for an off-route user, so that group meals could be had and so that the group can loosely stay together.

Once confirmation is received from the other drivers 619, the process checks to see if communication is desired with one or more drivers 621. In this example, the process allows the drivers in a group to immediately communicate if an off-route driver is detected. This allows the drivers to share dialogue related to the off-route condition and understand why a vehicle is off-route. In other instances, if the off-route is not a severe mis-route, the users may decide not to communicate, and the process can resume map updating.

If communication is desired, the process can establish communication between one or more users by opening communication channels 623. Not all users need participate in the communication, each user can choose whether or not to participate in the session. Communication is then processed accordingly 625 and the coordinate update procedure can also continue.

FIG. 7 shows an illustrative example of a group chat process. This is a limited example of how a communication process between a plurality of users can occur. Each user can receive a communication request 701 and/or initiate a communication request 701. If the communication request is sent to other users, at least one user must accept the request 703 for the communication to occur. Alternatively, if the request was received by the user, the process will continue if the user accepts the incoming request 703.

Once acceptance of a request has occurred, the process will open a chat session between two or more users 705. The chat can then commence using audio, video or any other suitable format. The chat session continues until sufficient users have ended 707 the chat session such that only one user remains.

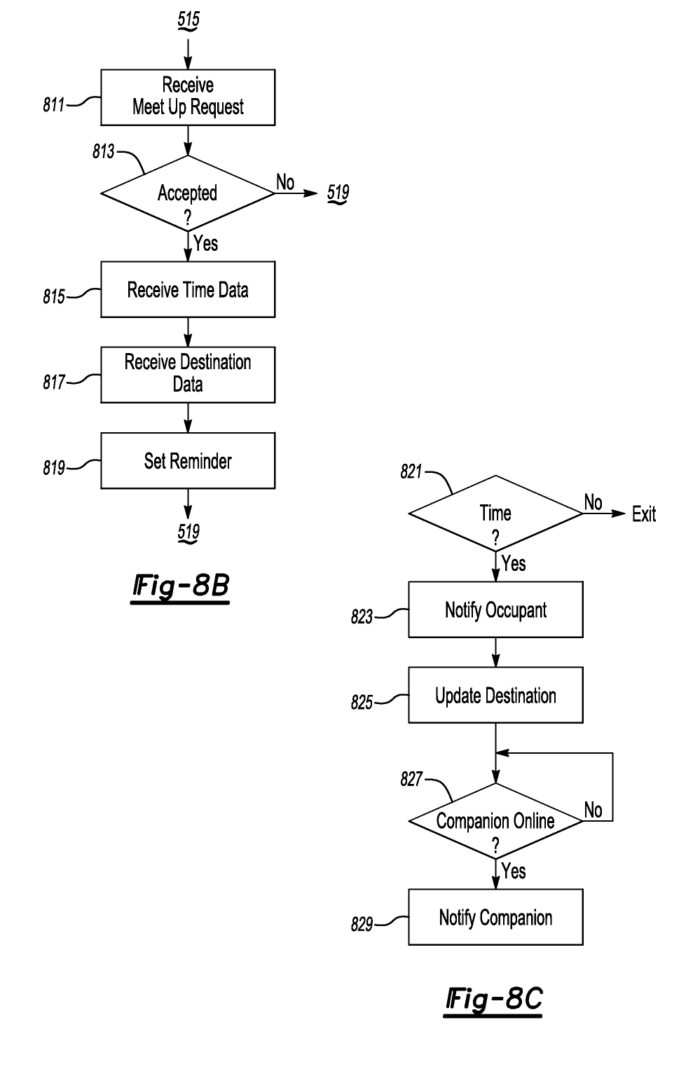

FIGS. 8A-8C show illustrative processes for group meet up handling. In FIG. 8A, the process is shown from the perspective of a user who initiates a group meet up request. For example, if the user wanted to see a movie, they may send out a number of requests, including a movie time and location. These requests can be sent to currently on-line friends, and can even be queued for delivery to off-line friends when they come online (until the prescribed time has passed).

In this illustrative example, the process sends the meet-up request to one or more selected users or groups of users 801. As noted, the request can include a destination (movies, restaurant, etc.) and/or a time/date for the intended meeting. Since the request may only be desired to be fulfilled if the user receives a positive response, the process may wait until one or more responses is received 803.

If anyone responds positively, the process may send destination data (such as an address) and date and time date (for calendar updating). The receiving process is described with respect to FIG. 8B. Also, in the sending vehicle, the process sets a reminder in a local calendar. Then, when the prescribed time approaches, the user can be reminded about the meeting and the destination data can be used to set a destination for the vehicle 807.

FIG. 8B shows an illustrative example of receiving a meet-up request 811. In this example, a different driver has sent out a meet-up request and the current driver receives the request 811. If the request is accepted by the current driver 813, the process then receives date and/or time data relating to the request. Also, data such as destination data may be received 817. Using this data, the process may use a local calendar application to set a reminder 819.

FIG. 8C shows an illustrative example of handling a meeting request reminder. After the meeting request was automatically set, a date, time and destination could be stored in a calendar. If the prescribed time has arrived or is proximate 821, the application could begin delivery of the data. In one example, the reminder application may consider a user's current location and an estimated time to the appropriate destination. For example, if the meeting is in 30 minutes, the process may inform the user of an impending appointment such that the user will arrive 5-10 minutes before the meeting. The process can examine a current location, a distance/time to destination, and provide the meeting reminder accordingly 523.

Once the occupant has been notified, the process then can update a destination for the vehicle 525. The user may have to agree to this update, and it will serve to replace the current vehicle destination, if any. Also, in this example, the process determines if other members of the meet-up are online 527. When the one or more other users comes online, the process can notify the other companions that the user is en-route to the destination 529. Additionally or alternatively, the process can form a group between all online meet-up users, such as with the group driving process shown previously herein.

Using the illustrative embodiments, drivers can participate in a number of social network groupings to facilitate a more pleasant and connected driving experience. The various users can communicate, update statuses and otherwise interact with other drivers. Additionally, an OEM can use information collected to provide advertisements, content and other desirable user media.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
communicate with a remote server to receive a list of friends who are currently driving their respective vehicles;
display the list of friends in a selectable manner;
receive selection of one or more friends from the list; and
send data to the remote server to be shared with the one or more selected friends.

2. The system of claim 1, wherein the list is touch-selectable.

3. The system of claim 1, wherein the data includes video data.

4. The system of claim 1, wherein the data includes audio data.

5. The system of claim 1, wherein the processor is further configured to open a wireless enabled chat session with the selected friends, using the server to transmit data between parties.

6. The system of claim 1, wherein the data includes a driver destination.

7. The system of claim 1, wherein the data includes a current vehicle location.

8. A computer-implemented method comprising:
communicating with a remote server to receive a list of friends who are currently driving their respective vehicles;
displaying the list of friends in a selectable manner;
receiving selection of one or more friends from the list; and
sending data to the remote server to be shared with the one or more selected friends.

9. The method of claim 8, wherein the list is touch-selectable.

10. The method of claim 8, wherein the data includes video data.

11. The method of claim 8, wherein the data includes audio data.

12. The method of claim 8, further comprising opening a wireless enabled chat session with the selected friends, using the server to transmit data between parties.

13. The method of claim 8, wherein the data includes a driver destination.

14. The method of claim 8, wherein the data includes a current vehicle location.

15. A computer readable storage medium storing instructions that, when executed by a processor of a vehicle computing system, cause the processor to perform a method comprising:
communicating with a remote server to receive a list of friends who are currently driving their respective vehicles;
displaying the list of friends in a selectable manner;
receiving selection of one or more friends from the list; and
sending data to the remote server to be shared with the one or more selected friends.

16. The storage medium of claim 15, wherein the list is touch-selectable.

17. The storage medium of claim 15, wherein the data includes video data.

18. The storage medium of claim 15, wherein the data includes audio data.

19. The storage medium of claim 15, wherein the method further includes opening a wireless enabled chat session with the selected friends, using the server to transmit data between parties.

20. The storage medium of claim 5, wherein the data includes a driver destination.
